(19) United States
(12) Patent Application Publication
(10) Pub. No.: US 2026/0155490 A1
(43) Pub. Date: Jun. 4, 2026

(54) Insulation Member

(71) Applicant: LG Chem, Ltd., Seoul (KR)

(72) Inventors: Taegyeong Kang, Seoul (KR); Moo Kwang Shin, Seoul (KR); Gyoeun Gu, Seoul (KR); Kyoungshil Oh, Seoul (KR)

(73) Assignee: LG Chem, Ltd., Seoul (KR)

(21) Appl. No.: 19/401,592

(22) Filed: Nov. 26, 2025

(30) Foreign Application Priority Data
Dec. 4, 2024 (KR) 10-2024-0178812

(51) Int. Cl. H01M 10/658; H01M 50/293

(52) U.S. Cl. CPC H01M 10/658; H01M 50/293

(57) ABSTRACT

An insulation member may include a silica insulation composite and a film positioned on a first surface of the silica insulation composite and a second surface of the silica insulation composite. The silica insulation composite includes a substrate and a silica network structure that includes a plurality of silica particles one or more pores. The insulation member may have an excellent elasticity recovery rate after compression.

### CROSS-REFERENCE TO RELATED APPLICATION

This application claims priority under 35 U.S.C. § 119 to Korean Patent Application No. 10-2024-0178812 filed on Dec. 4, 2024, the content of which is incorporated herein by reference in its entirety.

### TECHNICAL FIELD

The present disclosure relates to an insulation member.

### BACKGROUND

A silica insulation sheet comprising a fiber and a silica network structure is widely used as a functional insulation material in construction or industrial fields, and in particular, has recently been also applied as an insulation material for batteries in electric vehicles, and the like.

A battery used in an electric vehicle and the like is a high-output large-capacity battery, and a large amount of heat is generated during charging and discharging processes. If the heat generated as described above is not effectively removed, the possibility of ignition or explosion increases due to heat accumulation. Therefore, in order to prevent thermal runaway of the battery, a silica insulation sheet may be interposed between cells of the battery to achieve a heat blocking effect.

However, if the silica insulation sheet is applied as an insulation material for a battery, the battery cell undergoes repeated expansion and contraction during the charging and discharge processes. Periodic volume changes of the cell generate internal pressure and deformation, and the silica insulation sheet located between the cells also requires compression and restoring force in response thereto. However, if the silica insulation sheet does not have sufficient recovery elasticity after compression, the sheet may be excessively compressed when the volume of the cell expands, thereby causing structural collapse, and when the volume of the cell contracts again, the sheet may not be restored to its original state, thereby forming an empty space therein. This may not only cause degradation in insulation performance, but may also negatively affect the efficiency and stability of the battery. Particularly, as the battery is repeatedly charged and discharged, the above-described problem may become more severe.

### SUMMARY

An object of the present disclosure is to provide a silica insulation composite capable of effectively accommodating periodic volume changes of a cell that occur during charging and discharging of a battery, and an insulation member including the same.

Another object of the present disclosure is to provide a battery module and a battery pack including the insulation member.

However, the technical task to be achieved by the present disclosure is not limited to the aforementioned task, and other tasks that are not mentioned will be clearly understood by those skilled in the art from the following description.

According to an aspect of the present disclosure, there is provided an insulation member which includes a silica insulation composite comprising a substrate and a silica network structure including a plurality of silica particles and including one or more pores, and a film positioned on both surfaces of the silica insulation composite, wherein the insulation member has a thickness recovery rate of 70% or greater after compression, the thickness recovery rate calculated according to Equation 1 below.

$$Thickness recovery rate \text{} ( \% ) = [ Thickness of insulation member after secondary compression ] \text{} / [ \text{} Thickness of insulation member before compression ] \times 100 \qquad [ Equation 1 ]$$

In Equation 1 above, the thickness of the insulation member after secondary compression is a thickness of the insulation member subjected to primary compression until the thickness thereof after the compression reaches 50±5% of the thickness before the compression, and then subjected to secondary compression until the thickness of the insulation member reaches 40±5% of the thickness before the compression. More specifically, the thickness of the insulation member after secondary compression is a thickness of the insulation member measured after subjecting the insulation member to primary compression until the thickness thereof after the compression reaches 50±5% of the thickness before the compression, wherein the thickness is maintained for 60 minutes, followed by subjecting the insulation member to secondary compression until the thickness thereof reaches 40±5% of the thickness before the compression, wherein the thickness is maintained for 60 minutes, and then maintaining an environment without the pressure for 6 minutes.

The insulation member subjected to two or more times of a compression process including the primary compression and the secondary compression may have a thickness recovery rate (%) of 68% or greater.

The insulation member subjected to three times of a compression process including the primary compression and the secondary compression may have a thickness recovery rate (%) of 68% or greater.

The thickness of the insulation member measured after the two or more times of the compression process may be 0.90 times or greater than the thickness of the insulation member measured after one time of the compression process.

The insulation member may have a thickness of 0.5 mm to 10 mm.

The silica particles may include silica, methylsilylated silica, dimethylsilylated silica, trimethylsilylated silica, or a mixture thereof.

The silica network structure in the silica insulation composite may include a particle in which a plurality of silica particles having a particle diameter of greater than 0 nm to 5 nm are aggregated or coupled.

The aggregated or coupled particles may have an average particle diameter of 5 nm to 2,000 nm.

The silica insulation composite may have a density of 0.05 g/cm³ to 0.50 g/cm³.

According to another aspect of the present disclosure, there is provided a battery module including one or more battery cells in an internal space, and the above-described insulation member.

According to yet another aspect of the present disclosure, there is provided a battery pack including the above-described battery module.

### BRIEF DESCRIPTION OF THE DRAWINGS

Aspects of the present disclosure can be understood in more detail from the following description taken in conjunction with the accompanying drawings, in which:

FIG. 1 is a perspective view of an insulation member according to an aspect;

FIG. 2A is a perspective view of an insulation member according to an aspect;

FIGS. 2B and 2C are cross-sectional views of an insulation member according to an aspect;

FIG. 3 is a frontal view of an insulation member according to an aspect; and

FIG. 4 is a perspective view of an insulation member according to an aspect.

### DETAILED DESCRIPTION

Hereinafter, aspects of the present disclosure will be described in more detail to facilitate understanding of the present disclosure. In this case, it will be understood that words or terms used in the specification and claims shall not be interpreted as having the meaning defined in commonly used dictionaries. It will be further understood that the words or terms should be interpreted as having a meaning that is consistent with their meaning in the context of the relevant art and the technical idea of the disclosure, based on the principle that an inventor may properly define the meaning of the words or terms to best explain the disclosure.

According to an aspect of the present disclosure, the present disclosure relates to an insulation member which includes a silica insulation composite comprising a substrate and a silica network structure including a plurality of silica particles and including one or more pores, and a film positioned on both surfaces of the silica insulation composite.

The silica network structure refers to a network structure formed by three-dimensionally connecting a plurality of silica particles, wherein the structure forms a plurality of continuous pores between the silica particles, and the pores are connected to each other and distributed throughout a structural body.

The silica particle may include silica, methylsilylated silica, dimethylsilylated silica, trimethylsilylated silica, or a mixture thereof. In addition, the silica particles may include both primary particles having a size of approximately greater than 0 nm to less than or equal to 10 nm, or greater than 0 nm to less than or equal to 5 nm, or having a size of approximately 1 nm, and a secondary particle formed by aggregation of the above-described primary particles. The secondary particles may have an average particle diameter of approximately 5 nm to 2,000 nm, 5 nm to 1,000 nm, 5 nm to 500 nm, 5 nm to 100 nm, or 5 nm to 50 nm, but are not limited thereto. The above-described average particle size may be measured by any method known to those skilled in the art, such as scanning electron microscopy, dynamic light scattering, optical microscopy, or size exclusion, but the method is not limited thereto.

The pores included in the silica network structure may include mesopores, or may include micropores or macropores. Here, the “mesopore” is a pore having a pore diameter in the range of approximately 2 nm to approximately 50 nm, the “macropore” is a pore having a pore diameter in the range of greater than approximately 50 nm, and the “micropore” is a pore having a pore diameter in the range of less than approximately 2 nm. Mesopores of at least 50%, at least 60%, at least 70%, at least 80%, at least 90%, at least 95%, at least 96%, at least 97%, at least 98%, at least 99%, or 100% of the pore volume of the silica network structure may be included. In an aspect, the silica network structure may include mesopores. In an aspect, the silica network structure may include mesopores and micropores. The pore size may be measured by any means known to those skilled in the art, such as a gas adsorption experiment, mercury infiltration, capillary flow porometry, positron annihilation lifetime spectroscopy (PALS), or the like, but is not limited thereto.

The silica network structure is not particularly limited as long as it has the above-described network structure by including silica particles, and may include aerogel.

The “aerogel” includes a plurality of primary aerogel particles having a size of greater than approximately 0 nm to less than or equal to 10 nm, or greater than 0 nm to less than or equal to 5 nm, and a secondary aerogel particle formed by aggregation or combination of the above-described primary aerogel particles, and since a plurality of open pores are formed between the above-described primary aerogel particles and between the secondary aerogel particles to form an aggregate, the aerogel forms a three-dimensional network structure.

The aerogel may be inorganic silica aerogel formed from a silicon alkoxide-based compound or water glass as a precursor. As an example, the aerogel may include silica, methylsilylated silica, dimethylsilylated silica, trimethylsilylated silica, or a mixture thereof. As another example, the aerogel may be that at least a portion of SiO₂ present on the surface of a SiO₂ network structure has a bonding structure of Si—O—SiO₂(CH₃), Si—O—SiO(CH₃)₂, or Si—O—Si(CH₃)₃. A specific process for preparing silica aerogel will be described in detail below.

The substrate may be a fiber substrate including a plurality of fibers. The silica insulation composite has a structure in which at least some of a plurality of aerogel particles are dispersed, and in some aspects bonded, on the surface of a fiber in the substrate, and at the same time, has a structure in which at least some of the plurality of silica particles (or aerogel particles) are dispersed, and in some aspects positioned, in an empty space between discrete fibers in the substrate.

The “aerogel particles” are particles in the form of individual solid units constituting aerogel, and may include both primary aerogel particles having a size of greater than approximately 0 nm to less than or equal to 10 nm, or greater than 0 nm to 5 nm, or having a size of approximately 1 nm or less, and secondary aerogel particles formed by aggregation of the above-described particles. However, aerogel in a silica insulation composite is mostly in the form of secondary aerogel particles or in the form in which the secondary aerogel particles are aggregated and combined, and there may be trace mixtures of primary aerogel particles that do not form secondary aerogel particles. The secondary aerogel particles may have an average particle diameter of approximately 5 nm to 2,000 nm, 5 nm to 1,000 nm, 5 nm to 500 nm, 5 nm to 100 nm, or 5 nm to 50 nm, but are not limited thereto. In the present disclosure, the above-described average particle size may be measured by any method known to those skilled in the art, such as scanning electron microscopy, dynamic light scattering, optical microscopy, or size exclusion, but the method is not limited thereto.

The aerogel may have a matrix skeletal structure including mesopores, and may include micropores or macropores in addition to the mesopores. In the present disclosure, the aerogel may include mesopores of at least 50%, at least 60%, at least 70%, at least 80%, at least 90%, at least 95%, at least 96%, at least 97%, at least 98%, at least 99%, or 100% of the pore volume of the skeletal structure. In an aspect, the aerogel may include mesopores. In an aspect, the aerogel may include mesopores and micropores. The pore size may be measured by any means known to those skilled in the art, such as a gas adsorption experiment, mercury infiltration, capillary flow porometry, positron annihilation lifetime spectroscopy (PALS), or the like, but is not limited thereto.

Examples of the substrate may be a discrete fiber, a film, a sheet, a net, a fiber, a porous body, a foam, a non-woven body, or a laminate of two or more layers thereof. In addition, depending on the application thereof, the substrate may have surface roughness formed or patterned on the surface thereof.

The substrate may be polyester, polyolefin terephthalate, poly(ethylene) naphthalate, polycarbonate, regenerated cellulose (e.g., rayon), polyamide (e.g., nylon), cotton, spandex (e.g., Lycra manufactured by DuPont), carbon (e.g., graphite), polyacrylonitrile (PAN), oxidized PAN, non-carbonized heat-treated PAN (such as those made of SGL carbon), a glass fiber-based material (S-glass, 901 glass, 902 glass, 475 glass, E-glass, etc.), a silica-based fiber such as Quartz (e.g., Quartzel manufactured by Saint-Gobain), Q-Fiber felt (manufactured by Johns Manville), Saffil (manufactured by Saffil), Durablanket (manufactured by Unifrax) or other silica fibers, Duraback (manufactured by Carborundum), a polyaramid fiber such as Kevlar, Nomex, or Sontera (all manufactured by DuPont), Conex (manufactured by Teijin), a polyolefin such as Tyvek (manufactured by DuPont), Dyneema (manufactured by DSM), Spectra (manufactured by Honeywell), other polypropylene fibers such as Typar or Xavan (both manufactured by DuPont), a fluoropolymer such as PTFE under the trade name Teflon (manufactured by DuPont), Goretex (manufactured by W.L. GORE), a silicon carbide fiber such as Nicalcon (manufactured by COI Ceramics), ceramic paper, a ceramic fiber such as Nextel (manufactured by 3M), an acrylic polymer, a basalt fiber, wool, silk, hemp, leather, a suede fiber, a PBO-xylon fiber (manufactured by Toyobo), a liquid crystal material such as Vectan (manufactured by Hoechst), a Cambrelle fiber (manufactured by DuPont), polyurethane, a wool fiber, boron, aluminum, iron, a stainless steel fiber or other thermoplastic resins such as PEEK, PES, PET, PEK, PPS, or the like, but any fiber may be used without limitation as long as it is a fiber which includes spaces into which a silica three-dimensional structure, or an aerogel may be easily inserted, or voids, thereby improving insulation performance. As an example, the substrate may include glass fiber, basalt fiber, ceramic fiber, and/or ceramic paper, but is not limited thereto.

The substrate may have a thickness of 0.5 mm or greater, 1 mm or greater, 1.5 mm or greater, 2 mm or greater, 2.5 mm or greater, or 3 mm or greater, and may be 20 mm or less, 15 mm or less, 10 mm or less, 9 mm or less, 8 mm or less, 7 mm or less, 6 mm or less, 5 mm or less, 4 mm or less, 3.5 mm or less, or 3 mm or less. For example, the substrate may have a thickness of 0.5 mm to 20 mm, 0.5 mm to 10 mm, 0.5 mm to 5 mm, 0.5 mm to 4 mm, or 0.5 mm to 3.5 mm, but is not limited thereto.

The silica insulation composite may have a rectangular parallelepiped shape in which a substrate and a silica network structure (e.g., aerogel) are mixed from an upper surface to a lower surface, but is not limited thereto.

In addition, at least a portion of the upper surface or lower surface, or in some aspects the entire surface of the silica insulation composite, may have a flat shape. Here, the “flat shape” means that irregularities are not formed by an intentional embossing or coating process. In the present disclosure, by forming the upper and lower surfaces of the silica insulation composite to be flat as described above, it is possible to increase the ease of work in laminating a support member such as a sheet on the surface of the upper and lower surfaces in the future, and increase the adhesion retention rate of the support member. In addition, even if the silica insulation composite itself is directly applied as an insulation member without a support member, frictional force with the surface of a device positioned adjacent thereto may be reduced.

In addition, in the present disclosure, the silica insulation composite may have a thickness of 0.5 mm or greater, 1 mm or greater, 1.5 mm or greater, 2 mm or greater, 2.5 mm or greater, or 3 mm or greater, and may be 20 mm or less, 15 mm or less, 10 mm or less, 9 mm or less, 8 mm or less, 7 mm or less, 6 mm or less, 5 mm or less, 4 mm or less, 3.5 mm or less, or 3 mm or less. For example, the silica insulation composite may have a thickness of 0.5 mm to 20 mm, 0.5 mm to 10 mm, 0.5 mm to 5 mm, 0.5 mm to 4 mm, or 0.5 mm to 3.5 mm, but is not limited thereto.

In the present disclosure, the silica insulation composite may have a density of 0.05 g/cm³ to 0.50 g/cm³, 0.05 g/cm³ to 0.35 g/cm³, 0.05 g/cm³ to 0.30 g/cm³, 0.10 g/cm³ to 0.35 g/cm³, 0.10 g/cm³ to 0.30 g/cm³, 0.15 g/cm³ to 0.35 g/cm³, or 0.15 g/cm³ to 0.30 g/cm³, but is not limited thereto.

The silica insulation composite may have a thermal conductivity at room temperature (23±2° C.) of 30.0 mW/mK or less, 25.0 mW/mK or less, or 20.0 mW/mK or less, and within the above-described range, there is an effect of securing the insulation of the silica insulation composite to the maximum.

The silica insulation composite may have a thermal conductivity at a high temperature (150° C.) of 35.0 mW/mK or less, 30.0 mW/mK or less, or 25.0 mW/mK or less, and within the above-described range, there is an effect of securing the insulation of the silica insulation composite to the maximum.

The silica insulation composite has a compressive strength of 20 kPa to 80 kPa, 20 kPa to 70 kPa, 30 kPa to 80 kPa, 30 kPa to 70 kPa, 35 kPa to 80 kPa, or 35 kPa to 70 kPa at 10% deformation, and may have excellent mechanical strength. Here, the compressive strength may be measured by preparing a sample according to the ASTM C165 specifications.

The silica insulation composite has a tensile strength of 30 N/cm² to 60 N/cm², 40 N/cm² to 55 N/cm², or 45 N/cm² to 55 N/cm², and may have excellent flexibility. Here, the tensile strength may be measured by preparing a sample according to the ASTM D638 specifications.

A film may be positioned on both surfaces of the above-described silica insulation composite. In addition, a film may also be positioned on a side surface in a thickness direction of the silica insulation composite. Therefore, the silica insulation composite may have a structure encapsulated by the film.

The film may include a polyethylene (PE) resin, a polyethylene terephthalate (PET) resin, a polypropylene (PP) resin, or a mixture thereof. As an example, the film may be a PET film, but is not limited thereto.

The thickness of the film is not particularly limited, but may be, for example, 0.1 μm to 100 μm, 1 μm to 50 μm, 10 μm to 50 μm, or 25 μm to 40 μm.

In addition, on a surface facing the silica insulation composite of the both surfaces of the film, a pressure-sensitive adhesive layer or an adhesive layer may be positioned.

The pressure-sensitive adhesive layer or the adhesive layer may include an acrylic adhesive, a polyurethane adhesive, an olefin adhesive, an SBR rubber adhesive, or a silicone adhesive, but is not limited thereto.

The thickness of the pressure-sensitive adhesive layer or the adhesive layer is not particularly limited, but may be, for example, 0.1 μm to 100 μm, 1 μm to 50 μm, 10 μm to 50 μm, or 25 μm to 50 μm.

The film may have a calorific value of 1,000 J/g to 3,500 J/g, 1,100 J/g to 3,000 J/g, 1,500 J/g to 3,000 J/g, 2,000 J/g to 3,000 J/g, or 2,500 J/g to 3,000 J/g, but is not limited thereto.

In addition, the insulation member may have a thickness of 0.5 mm or greater, 1 mm or greater, 1.5 mm or greater, 2 mm or greater, 2.5 mm or greater, or 3 mm or greater, and may be 20 mm or less, 15 mm or less, 10 mm or less, 9 mm or less, 8 mm or less, 7 mm or less, 6 mm or less, 5 mm or less, 4 mm or less, 3.5 mm or less, or 3 mm or less. For example, the insulation member may have a thickness of 0.5 mm to 20 mm, 0.5 mm to 10 mm, 0.5 mm to 5 mm, 0.5 mm to 4 mm, or 0.5 mm to 3.5 mm, but is not limited thereto.

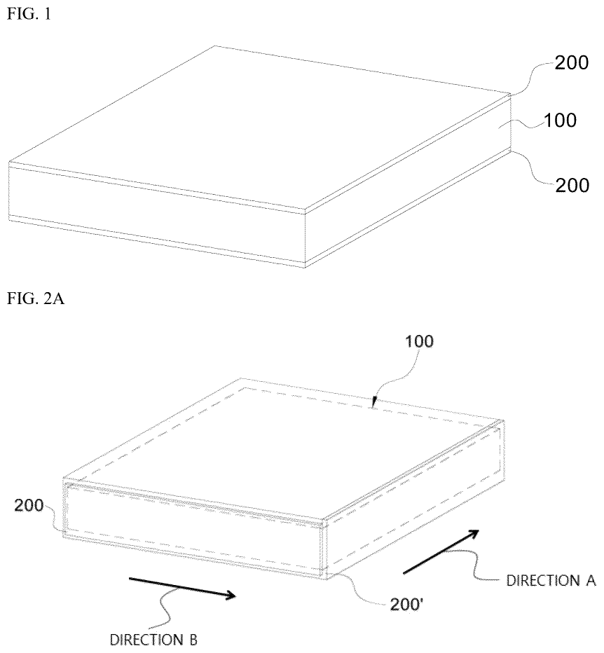

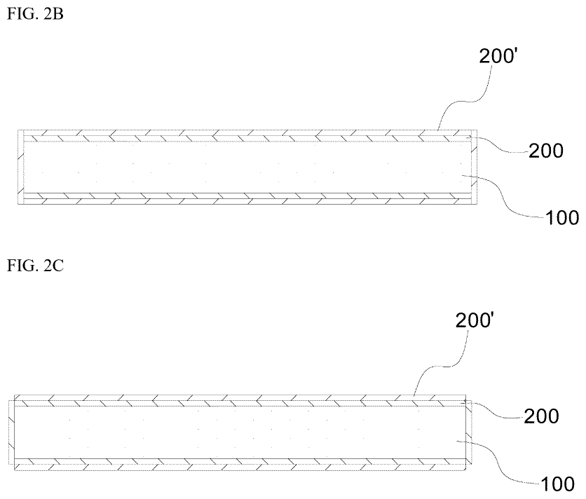

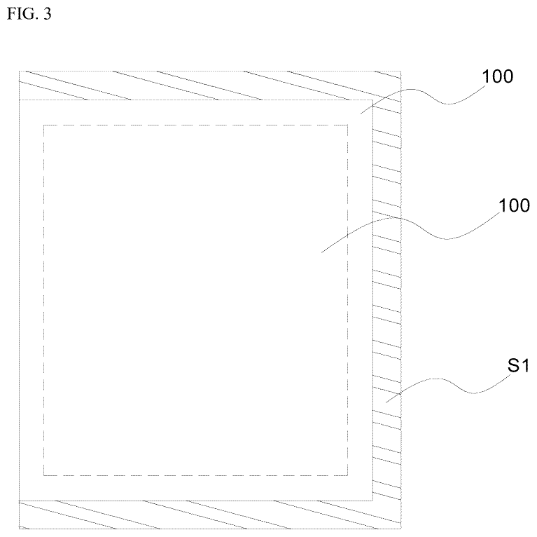

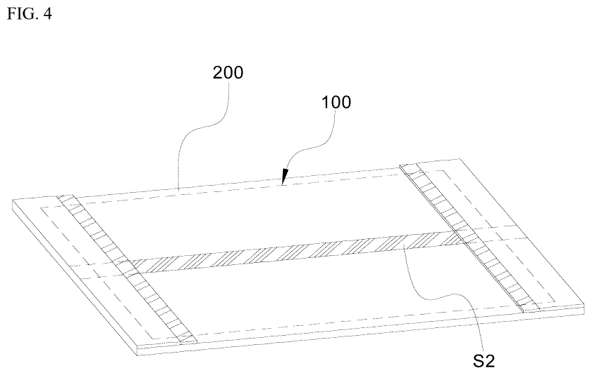

FIG. 1 is a perspective view of an insulation member according to an aspect, and shows a structure in which films 200 cut into a shape corresponding to an upper surface and a lower surface of a silica insulation composite 100 in the shape of a rectangular parallelepiped sheet are laminated. FIG. 2A illustrates a perspective view of an insulation member according to an aspect, and FIGS. 2B and 2C respectively illustrate cross-sectional views in a longitudinal direction and in a width direction. A long-cut film 200 is disposed to wrap the upper surface, a side surface, the lower surface, and the other side surface of the silica insulation composite 100 (dotted line) in the width direction (direction A). Another cut-film 200′ is disposed to wrap the upper surface, the side surface, the lower surface, and the side surface of the silica insulation composite in a longitudinal direction (direction B) perpendicular to the width direction (direction A). Therefore, two layers of the films 200 and 200′ are laminated on the upper surface and the lower surface of the silica insulation composite, but one layer of the film 200 or 200′ is laminated on the side surface of the silica insulation composite. In this case, two ends of one sheet of film may be bonded to each other by contacting each other at a corner (or at arbitrary position) of the silica insulation composite. Although not shown in the drawing, there may be a sealing portion formed by the two ends overlapping each other. FIG. 3 illustrates a frontal view of an insulation member according to another example, and shows a structure in which a silica insulation composite 100 is accommodated inside a folded film 200, and the film is bonded along an outer periphery of the silica insulation composite, thereby forming a sealing portion S1. Although not shown in the drawing, a structure in which a silica insulation composite is interposed between two films, and the two films are in contact along an outer periphery of the silica insulation composite, thereby forming a sealing portion is also included within the scope of the present disclosure. FIG. 4 illustrates a perspective view of an insulation member according to yet another aspect, and shows a structure in which a silica insulation composite 100 is positioned inside a film 200, and the film 200 is folded to wrap all surfaces of the silica insulation composite 100 according to the shape of the silica insulation composite 100, and two ends of the film 200 overlap on one surface of the silica insulation composite 100, thereby forming a sealing portion S2.

In a lithium ion battery, as the volume of a cell expands and contracts during charging and discharging processes, an insulation member interposed between the cells is also given an environment of compression and relaxation. When the battery is charged, the insulation member is compressed due to the volume expansion of the cell, and when the battery is discharged, the pressure applied to the insulation member is reduced due to the volume contraction of the cell. In this case, the insulation member should be elastically compressed and restored according to a change in the volume of the cell to have an effective insulation effect during a battery operation process. However, unless both the structural strength and the elasticity of the insulation member are excellent, the structure may collapse when the volume of the cell expands, or even if compression and recovery are achieved in an early stage of a battery cycle, the volume capacity of the insulation member may decrease rapidly as the volume change of the cell occurs repeatedly, causing the structure to collapse.

As a result of intensive research, the inventors of the present disclosure have developed an insulation member including a silica insulation composite having excellent elasticity restoring force against compression, thereby being capable of maintaining structural stability and insulation performance despite repeated volume changes due to repeated expansion and contraction of a cell during charging and discharging of a battery.

When the insulation member according to the present disclosure is primarily compressed to about 50% of its thickness and then secondarily compressed to about 40% of its thickness, the insulation member may have a thickness recovery rate of 70% or greater, 73% or greater, 75% or greater, 77% or greater, 80% or greater, 83% or greater, 85% or greater, 87% or greater, 90% or greater, 93% or greater, or 95% or greater.

The secondary compression and the primary compression respectively simulate the volume expansion of a cell due to charging and the volume contraction of the cell due to discharging during a battery operation.

The compression process may be performed by applying a pressure in a horizontal direction (transverse direction) with respect to a cross-section of the insulation member. That is, it means applying a force (pressure) to the insulation member in a direction from an upper surface to a lower surface of the insulation member or in a direction from the lower surface to the upper surface thereof, that is, in a thickness direction. In this case, a specific pressure intensity is not particularly limited, and as long as it is an intensity that can reduce the thickness of the insulation member to the above-described range due to compression, the intensity may be included without limitation. However, as a non-limiting example thereof, a pressure may be applied to an intensity of 0.5 kPa to 10 kPa, 0.5 kPa to 5 kPa, 1 kPa to 5 kPa, 0.5 kPa to 3 kPa, or 1 kPa to 3 kPa.

Equipment used in the compression process is not particularly limited, and any equipment capable of maintaining the compressed state of an insulation member for a predetermined period of time by applying a force in a thickness direction of the insulation member may be used without limitation. As an example, equipment including a plate capable of fixing a specimen and a compression jig capable of applying a pressure to the specimen in a thickness direction may be used.

During the primary compression, when the insulation member is compressed such that the thickness of the insulation member after the compression reaches about 50% (i.e., 50±5%) of the thickness thereof before the compression, such a compressed state may be maintained for 40 minutes or more, 50 minutes or more, 60 minutes or more, or 70 minutes or more, and 80 minutes or less. For example, the compressed state may be maintained for about 60 minutes.

After the primary compression, the insulation member is secondarily compressed to a pressure intensity greater than that of the primary compression. The secondary compression is performed subsequent to the primary compression, and may not include a rest period with no pressurization between the primary compression and the secondary compression. During the secondary compression, when the thickness of the insulation member reaches about 40% (i.e., 40±5%) of the thickness thereof before the compression (before the primary compression, initial thickness), such a compressed state may be maintained for 40 minutes or more, 50 minutes or more, 60 minutes or more, or 70 minutes or more, and 80 minutes or less. For example, the compressed state may be maintained for about 60 minutes.

After the secondary compression, the insulation member may have a thickness recovery rate (%) of 70% or greater, 73% or greater, 75% or greater, 77% or greater, 80% or greater, 83% or greater, 85% or greater, 87% or greater, 90% or greater, 93% or greater, or 95% or greater. The thickness recovery rate may be calculated according to Equation 1 below. That is, the thickness recovery rate is a percentage (%) of the thickness of the insulation member measured after removing the pressure applied to the insulation member after the secondary compression with respect to the thickness of the insulation member before the compression.

$$Thickness recovery rate \text{} ( \% ) = [ Thickness of insulation member after secondary compression ] \text{} / [ \text{} Thickness of insulation member before compression ] \times 100 \qquad [ Equation 1 ]$$

In Equation 1 above, the unit of thickness of the insulation member for measuring the thickness recovery rate of the insulation member is not particularly limited, and may be cm or mm. In some aspects, the unit of thickness is mm.

In addition, in Equation 1 above, the “thickness of the insulation member after the secondary compression” may be measured in a state in which all of the pressure applied to the insulation member is removed after the secondary compression (after a second pressurization maintenance process), that is, in an uncompressed state. At this time, the thickness of the insulation member may be measured after maintaining the uncompressed state for 3 minutes or more, 4 minutes or more, 5 minutes or more, 6 minutes or more, or 7 minutes or more, and 10 minutes or less. For example, the thickness of the insulation member may be measured after maintaining the uncompressed state for about 6 minutes.

The insulation member according to the present disclosure has excellent elasticity recovery despite repeated volume changes of a cell.

After a compression process including the primary compression and the secondary compression is repeated two or more times for the insulation member, the insulation member may have a thickness recovery rate (%) of 68% or greater, 70% or greater, 73% or greater, 75% or greater, 77% or greater, 80% or greater, 83% or greater, 85% or greater, 87% or greater, 90% or greater, 93% or greater, or 95% or greater. At this time, the upper limit of the thickness recovery rate is not particularly limited, but may be 100% or less, or 98% or less, 95% or less, or 93% or less.

Performing the compression process repeatedly two times for the insulation member is to simulate an environment in which the volume expansion and the volume contraction of a battery cell occur repeatedly, and may be performed in a manner in which the insulation member is subjected to a compression process including the primary compression and the secondary compression, and then is subsequently subjected to the primary compression and the secondary compression again without a rest period. At this time, the unit of compression process including the primary compression and the secondary compression may be repeated two or more times, three or more times, four or more times, five or more times, six or more times, seven or more times, eight or more times, nine or more times, or ten or more times.

In addition, after the compression process including the primary compression and the secondary compression is repeated two or more times for the insulation member, the thickness recovery rate (%) of the insulation member may be measured in a state (uncompressed state) in which all of the pressure applied to the insulation member is removed after the secondary compression of the last performed compression process. At this time, the uncompressed state may be maintained for 3 minutes or more, 4 minutes or more, 5 minutes or more, 6 minutes or more, or 7 minutes or more, and 10 minutes or less. For example, the uncompressed state may be maintained for about 6 minutes.

As an example, after the compression process including the primary compression and the secondary compression is repeated two times for the insulation member, the thickness recovery rate (%) of the insulation member measured may be 68% or more, 70% or greater, 73% or greater, 75% or greater, 77% or greater, 80% or greater, 83% or greater, 85% or greater, 87% or greater, 90% or greater, or 93% or greater, and 100% or less, 98% or less, or 95% or less.

As an example, after the compression process including the primary compression and the secondary compression is repeated three times for the insulation member, the thickness recovery rate (%) of the insulation member measured may be 68% or greater, 70% or greater, 73% or greater, 75% or greater, 77% or greater, 80% or greater, 83% or greater, 85% or greater, 87% or greater, or 90% or greater, and 100% or less, 98% or less, or 95% or less.

In addition, the thickness of the insulation member measured after two or more times of the compression process may be 0.90 times or greater, 0.91 times or greater, 0.92 times or greater, 0.93 times or greater, 0.94 times or greater, 0.95 times or greater, 0.96 times or greater, 0.97 times or greater, 0.98 times or greater, or 0.99 times or greater than the thickness of the insulation member measured after one time of the compression process. At this time, the upper limit is not particularly limited, but may be one time or less.

As an example, the thickness of the insulation member measured after two times of the compression process may be 0.90 times or greater, 0.91 times or greater, 0.92 times or greater, 0.93 times or greater, 0.94 times or greater, 0.95 times or greater, 0.96 times or greater, 0.97 times or greater, 0.98 times or greater, or 0.99 times or greater than the thickness of the insulation member measured after one time of the compression process. At this time, the upper limit is not particularly limited, but may be one time or less.

As an example, the thickness of the insulation member measured after three times of the compression process may be 0.90 times or greater, 0.91 times or greater, 0.92 times or greater, 0.93 times or greater, 0.94 times or greater, 0.95 times or greater, 0.96 times or greater, 0.97 times or greater, 0.98 times or greater, or 0.99 times or greater than the thickness of the insulation member measured after one time of the compression process. At this time, the upper limit is not particularly limited, but may be one time or less.

The thickness recovery rate of the insulation member after the compression process may be measured by the following method, but is not limited thereto. A specimen of the insulation member is placed between compression jigs, and the initial thickness of the specimen is measured by adjusting the height of the compression jig at a rate of 5 mm/min to 10 mm/min, for example, about 8 mm/min, such that a pressure of 1 kPa to 5 kPa, for example, about 2 kPa, is applied to the specimen. The specimen is pressed by adjusting the jig at a rate of 8 mm/min such that the thickness of the specimen is to be 50% of the measured initial thickness, and then is maintained for 60 minutes. Thereafter, the specimen is pressed by adjusting the compression jig at a rate of 8 mm/min such that the thickness of the specimen is to be 40% of the initial thickness, and then is maintained for 60 minutes. Thereafter, the compression jig is released at a rate of 8 mm/min such that the pressure applied to the specimen becomes 0, which is maintained for 6 minutes. When 6 minutes has elapsed, the final thickness of the specimen is measured by adjusting the height of the compression jig at a rate of 8 mm/min such that a pressure of 2 kPa is applied to the specimen. Even when measuring the thickness of an uncompressed specimen, there may be deviations in the thickness measurement value due to natural volume changes or surface non-uniformity of a silica insulation composite material. Therefore, when measuring the thickness of a specimen before (intentional) compression or after the compression, the thickness thereof may be measured by applying a low pressure, for example, a pressure of about 2 kPa, to the specimen. However, applying a pressure to measure the thickness of an uncompressed specimen, and the intensity of the pressure applied at this time are not limited to 2 kPa, and any method for reproducibly measuring the thickness of a specimen may be included without limitation.

The size of the specimen of the insulation member used in the above-described experiment is not particularly limited, but for example, a specimen having a size of 5 mm×5 mm in width×length may be used.

The thickness recovery rate of the insulation member after the compression may be obtained by randomly obtaining a total of five hexahedral specimens from the insulation member, and calculating an average value of thickness recovery rates respectively measured for specimens. At this time, the five specimens may be obtained by obtaining four specimens by positioning a position, which is spaced apart by 10 cm in a center direction from each corner of the insulation member prepared in a rectangular shape (e.g., which may have a size of about 60 cm×12 cm in width×length, but is not limited thereto) at the exact center of each specimen, and obtaining one specimen by positioning the exact central portion of the insulation member also at the exact center of each specimen, but is not limited thereto, and specimens obtained at any arbitrary position may be used.

As described above, the insulation member having excellent restoration recovery force against compression provided by the present disclosure may be applied as an insulation member for a battery, but may also be applied as an insulation member, thermal insulation member, or non-combustible material in the fields of construction, aviation, automobiles, home appliances, semiconductors, or industrial facilities.

A method for manufacturing the insulation member of the present disclosure may include preparing a silica insulation composite, and wrapping the silica insulation composite with a film. The silica insulation composite may be generally formed by preparing a silica sol, impregnating a substrate with the silica sol, and then performing gelation thereon, and drying the same. Hereinafter, each step will be described. However, the specific preparation processes or examples thereof described herein are not intended to be limited to any particular type of an aerogel composite or a preparation method thereof. The present specification may include any silica insulation composite formed by any associated preparation method known to those skilled in the art.

### Preparation of Silica Sol

In the present disclosure, a silica precursor composition may be used to prepare a silica sol.

The silica precursor composition includes a silica precursor, in which case the silica precursor may be used without limitation as long as it is a precursor which may be used to form a silica three-dimensional network, for example, aerogel. For example, the silica precursor may be an alkoxide-based compound containing silicon, and may be tetraalkyl silicate such as tetramethyl orthosilicate (TMOS), tetraethyl orthosilicate (TEOS), methyl triethyl orthosilicate, dimethyl diethyl orthosilicate, tetrapropyl orthosilicate, tetraisopropyl orthosilicate, tetrabutyl orthosilicate, tetra secondary butyl orthosilicate, tetra tertiary butyl orthosilicate, tetrahexyl orthosilicate, tetracyclohexyl orthosilicate, or tetradodecyl orthosilicate. For example, the silica precursor may be tetraethyl orthosilicate (TEOS), but is not limited thereto.

In addition, the silica precursor may be a water glass solution. Here, the water glass solution may be a diluted solution in which distilled water is added to water glass and then mixed therewith, and the water glass may be sodium silicate (Na₂SiO₃) which is an alkali silicate salt obtained by melting silicon dioxide (SiO₂) and alkali.

In addition, the silica precursor may include a pre-hydrolyzed TEOS (HTEOS). The HTEOS is an ethyl silicate oligomer material having a wide molecular weight distribution, and when synthesized into an oligomer form from a TEOS monomer, physical properties such as gelation time may be adjusted, and thus, may be easily applied according to a user's reaction conditions. In addition, there is an advantage in that reproducible physical properties of a final product may be created. The HTEOS may typically be synthesized by a condensation reaction of TEOS which has undergone a partial hydration step under acidic conditions. That is, the HTEOS is in the form of an oligomer prepared by condensing TEOS, wherein the oligomer is partially hydrated.

The pre-hydrolyzed silica precursor may be prepared by mixing a silica precursor and an organic solvent in a weight ratio of 1:0.1 to 1.5, 1:0.5 to 1.5, or 1:0.5 to 1.2, but is not limited thereto.

In addition, the pre-hydrolyzed silica precursor may be prepared by mixing a silica precursor and water in a molar ratio of 1:0.1 to 10, 1:1 to 8, or 1:2 to 6, but is not limited thereto.

In the present disclosure, the silica precursor composition may further include silicate including a hydrophobic group. In the present disclosure, the type of the silicate including a hydrophobic group is not limited as long as it is an alkyl silane compound including an alkyl group inducing hydrophobization and a silane functional group capable of reacting with an —Si—O-functional group of a wet gel, but specific examples thereof may include one or more selected from the group consisting of methyltriethoxysilane (MTES), trimethylethoxysilane (TMES), trimethylsilanol (TMS), methyltrimethoxysilane (MTMS), dimethyldiethoxysilane (DMDES), ethyltriethoxysilane (ETES), and phenyltriethoxysilane (PTES), but are not limited thereto. For example, in order to increase pore strength and elasticity of gel, the silica precursor composition may include one or more silicates selected from trimethylethoxysilane (TMES) and dimethyldiethoxysiloxane (DMDES).

When the silicate including a hydrophobic group is included in the silica precursor composition, the silicate including a hydrophobic group and the tetraalkyl silicate may be included in a molar ratio (molar ratio of silicate including a hydrophobic group:tetraalkyl silicate) of 9:1 to 1:9. Within the above-described range, the strength and insulation performance of the silica insulation composite may be improved.

In addition, the silica concentration of the silica precursor composition may be 10 kg/m³ to 100 kg/m³, 20 kg/m³ to 80 kg/m³, 30 kg/m³ to 70 kg/m³, 30 kg/m³ to 60 kg/m³, or 35 kg/m³ to 45 kg/m³, but is not limited thereto. The silica concentration is the concentration of the silica included in the silica precursor with respect to the silica precursor composition, and may be suitably adjusted by varying the contents of a silica precursor, an organic solvent, and water.

The silica precursor may be used in an amount such that the content of silica contained in the silica sol is to be 0.1 wt % to 30 wt %, but is not limited thereto. If the content of the silica satisfies the above-described range, both the mechanical properties and the insulation of the silica insulation composite may be improved.

The silica sol may include water and/or a polar organic solvent in the silica precursor composition.

When preparing the silica sol, the silica sol may be prepared by mixing the silica precursor composition and water in a molar ratio of 1:1 to 10, 1:2 to 10, or 1:5 to 10, but is not limited thereto.

The polar organic solvent may include an alcohol, and specific examples thereof may include a monohydric alcohol such as methanol, ethanol, isopropanol, and butanol, a polyhydric alcohol such as glycerol, ethylene glycol, propylene glycol, diethylene glycol, dipropylene glycol, and sorbitol, or a combination thereof, but other solvents as known to those skilled in the art may also be used without limitation. In the present disclosure, when considering the miscibility with water and aerogel, the polar organic solvent may be a monohydric alcohol having 1 to 6 carbon atoms such as methanol, ethanol, isopropanol, or butanol, and may be, for example, ethanol.

The polar organic solvent may be used in an appropriate amount by those skilled in the art in consideration of the degree of hydrophobicity in a silica insulation composite to be finally prepared while promoting a surface modification reaction.

When preparing the silica sol, the silica sol may be prepared by mixing the silica precursor composition and an organic solvent in a weight ratio of 1:1 to 10, 1:2 to 8, or 1:2 to 6, but is not limited thereto.

When preparing the silica sol, an acid catalyst may be further included, and specifically, an acid catalyst may be further included when applying an alkoxy silane-based compound, which is not a hydrolysate, as a precursor. In this case, the acid catalyst may be used without limitation as long as it is an acid catalyst which allows the pH to be 3 or less, and as an example, a hydrochloric acid, a nitric acid, a sulfuric acid, a phosphoric acid, an oxalic acid, or an acetic acid may be used. In this case, the acid catalyst may be added in an amount which allows the pH of the sol to be 3 or less, and may be added in the form of an aqueous solution in which the acid catalyst is dissolved in an aqueous solvent.

The catalyst composition may include, as a base catalyst, an inorganic base such as sodium hydroxide or potassium hydroxide, or an organic base such as ammonium hydroxide. Specific examples thereof may include sodium hydroxide (NaOH), potassium hydroxide (KOH), calcium hydroxide (Ca(OH)₂), ammonia (NH₃), ammonium hydroxide (NH₄OH; ammonia water), tetramethylammonium hydroxide (TMAH), tetraethylammonium hydroxide (TEAH), tetrapropylammonium hydroxide (TPAH), tetrabutylammonium hydroxide (TBAH), methylamine, ethylamine, isopropylamine, monoisopropylamine, diethylamine, diisopropylamine, dibutylamine, trimethylamine, triethylamine, triisopropylamine, tributylamine, choline, monoethanolamine, diethanolamine, 2-aminoethanol, 2-(ethyl amino) ethanol, 2-(methyl amino) ethanol, N-methyl diethanolamine, dimethylaminoethanol, diethylaminoethanol, nitrilotriethanol, 2-(2-aminoethoxy) ethanol, 1-amino-2-propanol, triethanolamine, monopropanolamine, dibutanolamine, pyridine, a combination thereof, or the like, but are not limited thereto.

The base catalyst may be included in an amount which allows the pH of the sol to be 7 to 11. If the pH of the sol is out of the above range, gelation may not be easily achieved or a gelation rate may be too low, so that processability may be degraded. In addition, since the base may be precipitated when introduced in a solid phase, the base may be added in a solution phase diluted by an aqueous solvent or the above-described organic solvent. In this case, the dilution ratio of the base catalyst and the organic solvent, specifically an alcohol, may be 1:4 to 1:100 based on a volume basis, but is not limited thereto.

In order to prepare the silica sol, the silica precursor composition and the catalyst composition may be mixed in a volume ratio of 1:0.01 to 10.0, 1:0.01 to 5.0, or 1:0.01 to 2.0, but is not limited thereto.

The silica sol may further include a cross-linking agent such as diethylene glycol, which may serve as a cross-linker during gelation, to increase structural strength and elasticity of the silica insulation composite. The cross-linking agent may be added in an amount of 0.5 parts by weight to 20 parts by weight, 0.5 parts by weight to 15 parts by weight, 0.5 parts by weight to 10 parts by weight, or 1 part by weight to 8 parts by weight based on 100 parts by weight of the silica sol, but is not limited thereto.

In addition, the silica sol may further include core-shell rubber (CSR), which imparts elasticity during gelation, to increase the structural strength and elasticity of the silica insulation composite. The core-shell rubber may be added in an amount of 0.5 parts by weight to 20 parts by weight, 0.5 parts by weight to 15 parts by weight, 0.5 parts by weight to 10 parts by weight, or 1 part by weight to 8 parts by weight based on 100 parts by weight of the silica sol, but is not limited thereto.

In addition, if necessary, an additive may be further added to the silica sol. In this case, all known additives which may be added when preparing aerogel may be applied as the additive, and for example, an additive such as a flame retardant and an opacifying agent may be used. The above-described additive may be added in an amount of 0.1 parts by weight to 10 parts by weight, 0.1 parts by weight to 5 parts by weight, 0.1 parts by weight to 3 parts by weight, or 0.1 part by weight to 1 parts by weight based on 100 parts by weight of the silica sol, but is not limited thereto.

### Gelation of Silica Sol

In the present disclosure, after the silica sol is impregnated into the substrate, the silica sol may be subjected to gelation.

The impregnation process is a process of allowing a catalyzed silica sol to permeate into pores inside the substrate, and may be performed by introducing the catalyzed silica sol and the substrate into a reaction vessel, or may be performed by spraying the catalyzed silica sol on the substrate which is moving on a conveyor belt according to a roll-to-roll process. At this time, in order to improve the bonding between the substrate and the silica sol, the substrate may be lightly pressed down to be sufficiently impregnated. Thereafter, the substrate may be pressed to a predetermined thickness with a predetermined pressure to remove excess silica sol, so that drying time may be reduced.

The temperature of the silica sol in the reaction vessel may be 10° C. to 40° C., 20° C. to 40° C., 25° C. to 40° C., 30° C. to 40° C., or 35° C. to 45° C. When the temperature of the silica sol in the reaction vessel satisfies the above range, the above-described viscosity range of the catalyzed sol may be more easily achieved, and even if the retention time is relatively short, a desired level of viscosity range may be achieved.

The catalyzed silica sol may be impregnated into the substrate. At this time, the catalyzed silica sol may be impregnated in a volume ratio (catalyzed silica sol:substrate) of 0.1 to 10:1 with respect to the substrate, or a volume ratio of 0.3 to 1.5:1, a volume ratio of 0.5 to 1.5:1, a volume ratio of 0.7 to 1.5:1, or a volume ratio of 0.7 to 1.2:1 to improve the strength and elasticity of gel.

The silica sol impregnated into the substrate may be subjected to gelation simultaneously with the impregnation process of the silica sol or sequentially after the impregnation process.

The substrate impregnated with the catalyzed sol may be subjected to gelation on a moving element such as a conveyor belt.

The “gelation” may refer to a sol-gel reaction, and the “sol-gel reaction” may be forming a network structure from a silicon unit precursor material. Here, the network structure may be a planar mesh structure in which specific polygons having one or more types of atomic arrangement are linked to each other, or a structure in which specific polyhedrons share their vertices, edges, faces, and the like with each other to form a three-dimensional skeletal structure.

The gelation may be performed at an ambient temperature of 20° C. to 40° C. or 25° C. to 35° C. in terms of increasing the pore strength of gel, but is not limited thereto.

In addition, the gelation time may be 1 minute to 120 minutes, 1 minute to 100 minutes, 1 minute to 60 minutes, 5 minutes to 60 minutes, 5 minutes to 40 minutes, 10 minutes to 40 minutes, 10 minutes to 30 minutes, or 10 minutes to 20 minutes, but is not limited thereto.

### Aging of Gelled Wet Gel Composite

In the present disclosure, if necessary, an aging step may be further included, which is leaving the wet gel composite obtained by gelation as described above to stand at an appropriate temperature so as to achieve a complete chemical change. In the aging step, the network structure formed by the gelation may be more robust, so that the mechanical stability of the silica insulation composite may be further improved.

The aging step may be performed by leaving the gelled wet gel composite to stand as it is at an appropriate temperature, or may be performed by adding a cross-linking-promoting compound.

The aging step may be performed by adding a solution in which a base catalyst such as sodium hydroxide (NaOH), potassium hydroxide (KOH), ammonium water (NH₄OH), triethylamine, pyridine, or the like is diluted to a concentration of 1 wt % to 20 wt %, or 1 wt % to 10 wt % in an organic solvent, in the presence of the wet gel composite. In this case, a Si—O—Si bonding in a silica network structure (e.g., aerogel) is induced to the maximum to allow the network structure of a silica gel to be firmer, so that there is an effect of facilitating the maintenance of the pore structure in a drying process be performed later. At this time, the organic solvent may be the alcohol described above, and specifically, may include ethanol.

In addition, in the aging step, a mixed solution of an alkoxy silane-based compound and an alcohol may be added to provide an additional sol precursor source as well as unreacted sol to induce additional gelation in the silica gel network structure, thereby further strengthening the gel structure. At this time, the alkoxy silane-based compound may be included in an amount of 0.5 parts by weight to 9.5 parts by weight, 1.0 part by weight to 9.5 parts by weight, or 1.5 parts by weight to 9.5 parts by weight based on the total 100 parts of the aging solution.

The alkoxy silane-based compound may include one or more selected from the group consisting of tetramethyl orthosilicate (TMOS), tetraethyl orthosilicate (TEOS), methyl triethyl orthosilicate, dimethyl diethyl orthosilicate, tetrapropyl orthosilicate, tetraisopropyl orthosilicate, tetrabutyl orthosilicate, tetra secondary butyl orthosilicate, tetra tertiary butyl orthosilicate, tetrahexyl orthosilicate, tetracyclohexyl orthosilicate, tetradodecyl orthosilicate, methyltrimethoxysilane (MTMS), methyltriethoxysilane (MTES), trimethylethoxysilane (TMES), trimethylsilanol (TMS), trimethylchlorosilane (TMCS), ethyltriethoxysilane (ETES), dimethyldiethoxysilane (DMDES), and phenyltriethoxysilane. For example, the alkoxy silane-based compound may be one or more selected from trimethylethoxysilane (TMES) and dimethyldiethoxysilane (DMDES).

The alcohol may specifically be a monohydric alcohol such as methanol, ethanol, isopropanol, or butanol, or a polyhydric alcohol such as glycerol, ethylene glycol, propylene glycol, diethylene glycol, dipropylene glycol, or sorbitol. For example, the alcohol may be a monohydric alcohol having 1 to 6 carbon atoms such as methanol, ethanol, isopropanol, or butanol, and among these, may be ethanol, but is not limited thereto.

The aging step may be performed by leaving the gelled wet gel composite to stand at a temperature of 30° C. to 80° C., 40° C. to 80° C., or 50° C. to 80° C. for 0.1 hours to 20 hours, 0.5 hours to 15 hours, 0.5 hours to 10 hours, 0.5 hours to 7 hours, or 1 hour to 6 hours to strengthen the pore structure, and within this range, it is possible to prevent an increase in production costs by preventing a loss of the solvent due to evaporation while preventing a decrease in productivity.

In addition, the aging step may be performed by performing primary aging of leaving the gelled wet gel composite at 30° C. to 80° C. for 0.1 hours to 5 hours to strengthen the pore structure, and then performing secondary aging at 30° C. to 80° C. for 0.1 hours to 20 hours, 0.5 hours to 15 hours, 0.5 hours to 10 hours, 0.5 hours to 7 hours, or 1 hour to 5 hours, by adding a solution in which the above-described basic catalyst is diluted in an organic solvent.

In addition, the aging step may be performed by performing primary aging of leaving the gelled wet gel composite at 30° C. to 80° C. for 0.1 hours to 5 hours to strengthen the pore structure, and then performing secondary aging at 30° C. to 80° C. for 0.1 hours to 20 hours, 0.5 hours to 15 hours, 0.5 hours to 10 hours, 0.5 hours to 7 hours, or 1 hour to 5 hours, by adding a solution in which the above-described basic catalyst is diluted in an organic solvent.

The aging step may be performed in a separate reaction vessel after recovering the gelled wet gel composite, or may be performed inside the reaction vessel in which the gelation step has been performed.

### Surface Modification of Aged Wet Gel Composite

The present disclosure includes a surface modification step of hydrophobizing the surface of the wet gel composite obtained by gelation as described above or the surface of the aged wet gel composite in the presence of a surface modifier.

As the surface modifier, a compound which hydrophobizes the surface of a wet gel may be applied without limitation, which may be, for example, a silane-based compound, a siloxane-based compound, a silanol-based compound, a silazane-based compound, or a combination thereof. Specific examples thereof may be a silane-based compound such as trimethylchlorosilane (TMCS), dimethyldimethoxysilane, dimethyldiethoxysilane, methyltrimethoxysilane (MTMS), methyltriethoxysilane (MTES), trimethylethoxysilane (TMES), vinyltrimethoxysilane, ethyltriethoxysilane, phenyltriethoxysilane, phenyltrimethoxysilane, tetraethoxysilane, dimethyldichlorosilane, and 3-aminopropyltriethoxysilane, a siloxane-based compound such as polydimethyl siloxane (PDMS), polydiethyl siloxane, and octamethyl cyclotetra siloxane, a silanol-based compound such as trimethylsilanol, triethylsilanol, triphenyl silanol, and t-butyldimethylsilanol, a silazane-based compound such as 1,2-diethyldisilazane, 1,1,2,2-tetramethyldisilazane, 1,1,3,3-tetramethyldisilazane, 1,1,1,2,2,2-hexamethyldisilazane (HMDS), 1,1,2,2-tetraethyldisilazane, or 1,2-diisopropyldisilazane, or a combination thereof, but are not limited thereto.

The surface modifier may be used in a solution phase diluted in an organic solvent. Here, the organic solvent may be an alcohol (an organic solvent), and at this time, the surface modifier may be diluted to 1 vol % to 15 vol %, 1 vol % to 10 vol %, or 1 vol % to 5 vol %, based on the total volume of the diluted solution.

In addition, the surface modifier may be added in an amount of 0.01 vol % to 95 vol %, 0.1 vol % to 90 vol %, 1 vol % to 90 vol %, 10 vol % to 90 vol %, 50 vol % to 90 vol %, or 70 vol % to 90 vol %, with respect to the wet gel composite for a sufficient surface modification effect, but is not limited thereto.

The surface modification step may be performed at a temperature of 50° C. to 90° C. or 50° C. to 80° C. for 1 hour to 24 hours, but is not limited thereto.

### Drying Step

In the present disclosure, a drying step of drying the surface-modified wet gel composite to obtain a silica insulation composite may be included.

The drying is performed as a process of removing only the solvent while maintaining the pore structure of the aged gel, and may be performed, for example, by supercritical drying or normal-pressure drying.

The supercritical drying process is performed using supercritical carbon dioxide, and for example, may be performed by placing the aged wet gel composite in a supercritical drying reactor, filling the reactor with CO₂ in a liquid state, performing a solvent replacement process of replacing an alcohol solvent inside the wet gel with CO₂, followed by raising the temperature to a temperature of 40° C. to 70° C. at a predetermined temperature increase rate, for example, a rate of 0.1° C./min to 1° C./min, and then maintaining a pressure equal to or higher than the pressure at which carbon dioxide becomes supercritical, for example, a pressure of 100 bar to 150 bar, thereby maintaining the supercritical state of carbon dioxide for a predetermined period of time, specifically, 20 minutes to 1 hour. In general, carbon dioxide becomes supercritical at a temperature of 31° C., and a pressure of 73.8 bar. After the predetermined temperature and the predetermined pressure at which carbon dioxide becomes supercritical are maintained for 2 hours to 12 hours, more specifically, 2 hours to 6 hours, the pressure is gradually removed to complete the supercritical drying process, thereby preparing a silica insulation composite, but the present disclosure is not limited thereto.

In addition, the normal-pressure drying process may be performed according to a typical method such as hot air drying or IR drying at a temperature of 70° C. to 200° C. and under a normal pressure (1±0.3 atm), but is not limited thereto.

In the present disclosure, when the silica insulation composite is prepared as described above, a step of wrapping the entire surface of the silica insulation composite with a film, thereby encapsulating the silica insulation composite may be included. An example of the above-described encapsulation process may be performed by cutting a film having a pressure-sensitive layer or an adhesive layer formed on one surface thereof into a shape corresponding to an outer surface of the silica insulation composite, and then adhering the film on the surface of the silica insulation composite, particularly on an upper surface and a lower surface thereof, using the pressure-sensitive layer or the adhesive layer (FIG. 1). As another example, a single film may be prepared, and then all of an upper surface-a side surface-a lower surface-a side surface of the silica insulation composite is wrapped by the film along a width direction (direction A) of the silica insulation composite. In addition, another single film may be prepared, and then all of the upper surface-the side surface-the lower surface-the side surface of the silica insulation composite is wrapped by the film along a longitudinal direction (direction B) of the silica insulation composite. At this time, the film may be cut and prepared in a corresponding shape and size to wrap all of the above-described surfaces (FIGS. 2A, 2B, and 2C). As another example, a single film may be prepared, and the silica insulation composite may be positioned on the film, following by folding the film, and if necessary, the film may be cut into a size to match the size of the silica insulation composite, and then an outer circumferential surface of the film may be thermally fused along an outer periphery of the silica insulation composite or may be sealed by sealing using other methods that use an adhesive or the like (FIG. 3). As another example, two films may be prepared, and the silica insulation composite may be interposed between the two films, and then the films and the silica insulation composite may be fused by thermal fusion, or two layers of films may be sealed by sealing along an outer circumferential surface of the silica insulation composite. As another example, the silica insulation composite is disposed in the center of a cut film, and the film may be folded according to the shape of the silica insulation composite such that the entire surface of the silica insulation composite is completely covered, and edges of the two films overlapping on any one surface of the silica insulation composite may be sealed (FIG. 4). At this time, the sealing method may include thermal fusion, use of an adhesive, ultrasonic fusion, and the like. However, a specific method of wrapping the silica insulation composite with a film is not particularly limited, and any process used for encapsulation or sealing of the silica insulation composite in the art may be included without limitation.

Another aspect of the present disclosure relates to a battery module or a battery pack including the insulation member according to the present disclosure.

The battery module may include a module case having an internal space and one or more battery cells present in the internal space.

The number of battery cells accommodated in the module case is not limited, and may be adjusted according to the use of the battery module. The battery cells accommodated in the module case may be electrically connected to each other. The type of the battery cell accommodated in the module case is not limited, but for example, the battery module may include a cylindrical, prismatic, or pouch-type case battery cell.

The battery module may include the insulation member according to the present disclosure in a module case of the battery module. The insulation member may be positioned between the battery cells accommodated in the module case. The insulation member may be disposed between the module case and the plurality of battery cells, that is, around the module case. A silica insulation composite positioned in the module case may serve as an insulator to reduce heat propagation in the battery module and improve the safety of the battery module.

The battery pack may include one or more of the battery modules. The battery modules may be electrically connected to each other in the battery pack. The battery pack may include the insulation member according to the present disclosure. For example, the insulation member may be positioned between the battery modules of the battery pack. The insulation member may also at least partially surround the plurality of battery modules in the battery pack. The insulation member may act as an insulation member in the battery pack to reduce heat transfer and improve the safety of the battery pack.

The present disclosure may include, but is not limited to, the following aspects in the scope of the present disclosure as an example:

The present disclosure relates to an insulation member which includes a silica insulation composite comprising a substrate and a silica network structure including a plurality of silica particles and including one or more pores, and a film positioned on both surfaces of the silica insulation composite, wherein the insulation member has a thickness recovery rate of 70% or greater after compression.

Thickness recovery rate (%)=[Thickness of insulation member after secondary compression]/[Thickness of insulation member before compression]×100 [Equation 1]

In Equation 1 above, the thickness of the insulation member after secondary compression is measured after subjecting the insulation member to primary compression until the thickness thereof after the compression reaches 50±5% of the thickness before the compression, wherein the thickness is maintained for 60 minutes, followed by subjecting the insulation member to secondary compression until the thickness thereof reaches 40±5% of the thickness before the compression, wherein the thickness is maintained for 60 minutes, and then maintaining an environment without the pressure for 6 minutes.
2. In the first aspect, the insulation member subjected to two or more times of a compression process including the primary compression and the secondary compression may have a thickness recovery rate (%) of 68% or greater.
3. In at least one of the first and second aspects, the insulation member subjected three times of a compression process including the primary compression and the secondary compression may have a thickness recovery rate (%) of 68% or greater.
4. In at least one of the first to third aspects, the thickness of the insulation material measured after the two or more times of the compression process may be 0.90 times or greater than the thickness of the insulation member measured after one time of the compression process.
5. In at least one of the first to fourth aspects, the insulation member may have a thickness of 0.5 mm to 10 mm.
6. In at least of the first to fifth aspects, the silica particles may include silica, methylsilylated silica, dimethylsilylated silica, trimethylsilylated silica, or a mixture thereof.
7. In at least of the first to sixth aspects, the silica network structure in the silica insulation composite may include a particle in which a plurality of silica particles having a particle diameter of greater than 0 nm to 5 nm are aggregated or coupled.
8. In the seventh aspect, the aggregated or coupled particles may have an average particle diameter of 5 nm to 2,000 nm.
9. In at least one of the first to eighth aspects, the silica insulation composite may have a density of 0.05 g/cm³ to 0.50 g/cm³.
10. In at least one of the first to ninth aspects, the silica network structure may include silica aerogel or may be silica aerogel.
11. In at least one of the first to tenth aspects, the silica insulation composite may be an aerogel composite including a substrate and silica aerogel having a plurality of open pores.
12. The present disclosure relates to a battery module including, in an internal space, one or more battery cells, and at least one insulation member of the first to eleventh aspects.
13. The present disclosure relates to a battery pack including a battery module which includes, in an internal space, one or more battery cells, and at least one insulation member of the first to twelfth examples.

Hereinafter, aspects of the present disclosure will be described in detail with reference to the following examples. However, the following examples are illustrative of the present disclosure, and the contents of the present disclosure are not limited by the following examples.

### EXAMPLES

### [Preparation Example 1] Preparation of Silica Insulation Composite

Methyltriethoxysilane (MTES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. To the silica sol prepared as described above, diethylene glycol (DEG) was added in an amount of 7.2 parts by weight based on 100 parts by weight of the silica sol. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 3 mm) as a substrate was passed therethrough to infiltrate the silica sol into the fiber, wherein the silica sol was impregnated into the fiber mat in a volume ratio of 0.7:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 12 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 2] Preparation of Silica Insulation Composite

Dimethyldiethoxysilane (DMDES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 35° C. After the gelation was completed, a wet gel composite was left to stand in an ethanol solution at a temperature of 70° C. for 1 hour to be aged. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 12 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 3] Preparation of Silica Insulation Composite

Tetraethyl orthosilicate (TEOS) and water were mixed in a molar ratio of 1:6, and ethanol was added thereto in a weight ratio of 1:1 with respect to TEOS to prepare a silica precursor solution. In order to promote hydrolysis of the silica precursor solution, a hydrochloric acid (HCl) aqueous solution was added to allow the pH of the silica precursor solution to be approximately 3 or less, and then the mixture was stirred for 2 hours or more to prepare a hydrated TEOS solution. Ethanol having a weight ratio of 1:4 with respect to the hydrated TEOS solution was added to prepare a silica sol. In order to facilitate hydrolysis, hydrochloric acid was added to allow the pH of the silica sol to be 3 or less. To the silica sol prepared as described above, diethylene glycol (DEG) was added in an amount of 1.2 parts by weight based on 100 parts by weight of the silica sol. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1.1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 12 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 4] Preparation of Silica Insulation Composite

Methyltriethoxysilane (MTES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1.2:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 35° C. After the gelation was completed, a wet gel composite was stabilized at room temperature (25° C.) for 10 minutes, and then subjected to primary aging in an oven at 70° C. for 30 minutes. Thereafter, a mixture of ethanol and ammonia water (volume ratio of 98:2) was prepared and added to the wet gel composite primarily aged in an amount of 1.6 times the volume of the silica sol, and then subjected to secondary aging in an oven at 70° C. for 5 hours. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 12 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 5] Preparation of Silica Insulation Composite

Methyltriethoxysilane (MTES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. To the silica sol prepared as described above, core-shell rubber (CSR) was added in an amount of 7.2 parts by weight based on 100 parts by weight of the silica sol. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 3 mm) as a substrate was passed therethrough to infiltrate the silica sol into the fiber, wherein the silica sol was impregnated into the fiber mat in a volume ratio of 0.7:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of dimethyldiethoxysilane (DMDES) in ethanol with a water content of 10 wt %, based on the volume of the wet gel composite, and then subjected to secondary aging in an oven at 75° C. for 2 hours. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 12 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 6] Preparation of Silica Insulation Composite

Dimethyldiethoxysilane (DMDES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. To the silica sol prepared as described above, core-shell rubber (CSR) was added in an amount of 1.2 parts by weight based on 100 parts by weight of the silica sol. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 3 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, a wet gel composite was stabilized at room temperature (25° C.) for 10 minutes, and then subjected to primary aging in an oven at 70° C. for 30 minutes. Thereafter, a mixture of ethanol and ammonia water (volume ratio of 98:2) was prepared and added to the wet gel composite primarily aged in an amount of 1.6 times the volume of the silica sol, and then subjected to secondary aging in an oven at 70° C. for 5 hours. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 12 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Preparation Example 7] Preparation of Silica Insulation Composite

Methyltriethoxysilane (MTES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. To the silica sol prepared as described above, diethylene glycol (DEG) was added in an amount of 1.2 parts by weight based on 100 parts by weight of the silica sol, and core-shell rubber (CSR) was added in an amount of 3.6 parts by weight based on 100 parts by weight of the silica sol. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 3 mm) as a substrate was passed therethrough to infiltrate the silica sol into the fiber, wherein the silica sol was impregnated into the fiber mat in a volume ratio of 0.7:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was stabilized at room temperature (25° C.) for 10 minutes, and then subjected to primary aging in an oven at 70° C. for 30 minutes. The wet gel composite primarily aged was added with 109% of a solution, which was prepared by diluting 2.9 wt % of methyltriethoxysilane (MTES) in ethanol with a water content of 10 wt %, based on the volume of the wet gel composite, and then subjected to secondary aging in an oven at 75° C. for 2 hours. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 12 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 1] Preparation of Silica Insulation Composite

Tetraethyl orthosilicate (TEOS) and water were mixed in a molar ratio of 1:4, and ethanol was added thereto in a weight ratio of 1:1 with respect to TEOS to prepare a silica precursor solution. In order to promote hydrolysis of the silica precursor solution, a hydrochloric acid (HCl) aqueous solution was added to allow the pH of the silica precursor solution to be approximately 2, and then the mixture was stirred for 2 hours or more to prepare a hydrated TEOS solution. Ethanol having a weight ratio of 1:3 with respect to the hydrated TEOS solution was added to prepare a silica sol. In order to facilitate hydrolysis, hydrochloric acid was added to allow the pH of the silica sol to be 3 or less. A base catalyst solution (30 wt % of ammonia water) having a volume ratio of 99.5:0.5 with respect to the silica sol was added to prepare a catalyzed sol. After filling 33.3 L of the catalyzed silica sol in an impregnation tank, a fiber (a basalt fiber mat, 3 mm) as a substrate was passed therethrough to infiltrate the silica sol into the fiber, wherein the silica sol was impregnated into the fiber mat in a volume ratio of 0.5:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. The gelled wet gel composite was added with 90 vol % of a solution (5 vol %) as a surface modifier, which was prepared by diluting hexamethyldisilazane (HMDS) in ethanol, based on the volume of the wet gel composite, and then subjected to surface modification at a temperature of 75° C. for 4 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 2] Preparation of Silica Insulation Composite

Tetraethyl orthosilicate (TEOS) and water were mixed in a molar ratio of 1:5, and ethanol was added thereto in a weight ratio of 1:1 with respect to TEOS to prepare a silica precursor solution. In order to promote hydrolysis of the silica precursor solution, a hydrochloric acid (HCl) aqueous solution was added to allow the pH of the silica precursor solution to be approximately 2, and then the mixture was stirred for 2 hours or more to prepare a hydrated TEOS solution. Ethanol having a weight ratio of 1:3 with respect to the hydrated TEOS solution was added to prepare a silica sol. In order to facilitate hydrolysis, hydrochloric acid was added to allow the pH of the silica sol to be 3 or less. A base catalyst solution (30 wt % of ammonia water) having a volume ratio of 99.5:0.5 with respect to the silica sol was added to prepare a catalyzed sol. After filling 33.3 L of the catalyzed silica sol in an impregnation tank, a fiber (a basalt fiber mat, 3 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, a wet gel composite was left to stand in an ethanol solution at a temperature of 70° C. for 1 hour to be aged. The aged wet gel composite was added with 90 vol % of a solution (5 vol %) as a surface modifier, which was prepared by diluting hexamethyldisilazane (HMDS) in ethanol, based on the volume of the wet gel composite, and then subjected to surface modification at a temperature of 75° C. for 4 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 3] Preparation of Silica Insulation Composite

Tetraethyl orthosilicate (TEOS) and water were mixed in a molar ratio of 1:4, and ethanol was added thereto in a weight ratio of 1:1 with respect to TEOS to prepare a silica precursor solution. In order to promote hydrolysis of the silica precursor solution, a hydrochloric acid (HCl) aqueous solution was added to allow the pH of the silica precursor solution to be approximately 3, and then the mixture was stirred for 2 hours or more to prepare a hydrated TEOS solution. Ethanol having a weight ratio of 1:6 with respect to the hydrated TEOS solution was added to prepare a silica sol. In order to facilitate hydrolysis, hydrochloric acid was added to allow the pH of the silica sol to be 3 or less. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 1:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, the wet gel composite was added with 109% of a solution, which was prepared by diluting 2.9 wt % of methyltriethoxysilane (MTES) in ethanol with a water content of 10 wt %, based on the volume of the wet gel composite, and then subjected aging in an oven at 75° C. for 1 hour. The aged wet gel composite was added with 90 vol % of a solution (5 vol %) as a surface modifier, which was prepared by diluting hexamethyldisilazane (HMDS) in ethanol, based on the volume of the wet gel composite, and then subjected to surface modification at a temperature of 75° C. for 4 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 4] Preparation of Silica Insulation Composite

Methyltriethoxysilane (MTES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. A base catalyst solution (30 wt % of ammonia water) having a volume ratio of 99.5:0.5 with respect to the silica sol was added to prepare a catalyzed sol. After filling 33.3 L of the catalyzed silica sol in an impregnation tank, a fiber (a basalt fiber mat, 2 mm) as a substrate was passed therethrough to infiltrate the silica sol into the fiber, wherein the silica sol was impregnated into the fiber mat in a volume ratio of 0.7:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 30° C. After the gelation was completed, a wet gel composite was left to stand in an ethanol solution at a temperature of 70° C. for 1 hour to be aged. The aged wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 4 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Comparative Preparation Example 5] Preparation of Silica Insulation Composite

Methyltriethoxysilane (MTES) and tetraethyl orthosilicate (TEOS) were mixed in a molar ratio of 97:3 to prepare a silica precursor composition. The silica precursor composition and water were mixed in a molar ratio of 1:10, and the silica precursor composition and ethanol were mixed in a weight ratio of 1:2 to prepare a silica sol. In order to facilitate hydrolysis, hydrochloric acid was added to allow the pH of the silica sol to be 3 or less. A base catalyst solution (5 wt % of NaOH aqueous solution) having a volume ratio of 99:1 with respect to the silica sol was added to prepare a catalyzed sol. After filling 33.3 L of the catalyzed silica sol in an impregnation tank, a fiber (a basalt fiber mat, 3 mm) as a substrate was passed therethrough to infiltrate the silica sol into the fiber, wherein the silica sol was impregnated into the fiber mat in a volume ratio of 0.5:1 (silica sol:fiber). The fiber which passed through the impregnation tank to allow the silica sol to infiltrate thereinto was gelled while moving on a conveyor belt at a predetermined rate. At this time, the ambient atmosphere temperature at the top of the conveyor belt was maintained at 25° C. After the gelation was completed, the wet gel composite was added with 90 vol % of a solution (10 vol %) as a surface modifier, which was prepared by diluting trimethylethoxysilane (TMES) in ethanol, based on the volume of the wet gel composite, and then subjected to surface modification at a temperature of 75° C. for 6 hours. The silica wet gel was placed in a 7.2 L supercritical extractor and CO₂ was injected thereto. Thereafter, the temperature inside the extractor was raised to 70° C. over the course of 1 hour and 20 minutes, and when 70° C. and 150 bar were reached, a cycle of injecting and discharging CO₂ at a rate of 0.5 L/min for 20 minutes and keeping the CO₂ injection stopped for 20 minutes was repeated for 4 times. At the time of injecting and discharging CO₂, the ethanol was recovered through a lower end of the extractor. Thereafter, CO₂ was vented over the course of 2 hours to prepare a hydrophobic silica aerogel composite.

### [Examples 1 to 7 and Comparative Examples 1 to 5] Preparation of Insulation Member

A specimen of each of the silica insulation composites prepared in Preparation Examples 1 to 7 and Comparative Preparation Examples 1 to 5 was prepared to have dimensions of approximately 60 cm×12 cm in width×length. As a film to wrap the silica insulation composite, a PET film (25 μm) coated with an acrylic adhesive to a thickness of about 50 μm on one surface thereof was prepared. The silica insulation composite was placed in the center of the PET film, and then the film was folded to wrap the entire surface of the silica insulation composite as shown in FIG. 4, and a portion in which the film overlaps was sealed using an adhesive to prepare an insulation member.

### [Experimental Example 1] Evaluation of Restoration Recovery Rate after Compression

The following experiments were performed to evaluate the recovery rate of a silica insulation composite according to volume changes of a cell when the silica insulation composite prepared according to the present disclosure is applied as an insulation member for a battery.

1. Evaluation of Thickness Recovery Rate after Performing Compression Process One Time

First, five specimens in a size of 5 mm×5 mm were prepared by cutting each of the film-attached silica insulation composites prepared in Examples 1 to 7 and Comparative Examples 1 to 5. Specifically, four specimens were obtained by positioning a position, which is spaced apart by 10 cm in a center direction from a corner of each of the silica insulation composites, at the exact center of a specimen, and one specimen was obtained by positioning the exact central portion of the insulation member at the exact center of a specimen as well. A specimen was placed between a circular compression jig (about 10 cm in diameter) of UTM equipment (5659 model by Instron Co., Ltd.), and the initial thickness of the specimen was measured by adjusting the height of the compression jig at a rate of 8 mm/min such that a pressure of 2 kPa was applied to the specimen. The specimen was pressed at a rate of 8 mm/min to have a thickness of 50(±5) % of the measured initial thickness, and the thickness was maintained for 60 minutes. Subsequently, the specimen was additionally pressed at a rate of 8 mm/min to have a thickness of 40(±5) % of the initial thickness, and the thickness was maintained for 60 minutes. Thereafter, the compression jig was adjusted at a rate of 8 mm/min such that the pressure applied to the specimen became 0. The above status was maintained for 6 minutes, and the final thickness of the specimen was measured by adjusting the height of the compression jig at a rate of 8 mm/min such that a pressure of 2 kPa was applied to the specimen. For each example, an average value of the initial thicknesses and an average value of the thicknesses after the secondary compression were calculated for five specimens, and the results were substituted into Equation 1 to obtain a thickness recovery rate. At this time, the thickness recovery rate was rounded to the first decimal place and is shown in Table 2.

$$Thickness recovery rate \text{} ( \% ) = [ Thickness of insulation member after secondary compression ] \text{} / [ \text{} Thickness of insulation member before compression ] \times 100 \qquad [ Equation 1 ]$$

TABLE 1

| | | Thickness | |
|---|---|---|---|
| | | (mm) after | |
| | | performing | |
| | Initial | compression | Thickness |
| | thickness | process one | recovery |
| | (mm) | time | rate (%) |
| Example 1 | 2.91 | 2.67 | 92% |
| Example 2 | 2.09 | 1.56 | 75% |
| Example 3 | 2.33 | 1.7 | 73% |
| Example 4 | 2.58 | 2.13 | 83% |
| Example 5 | 2.9 | 2.69 | 93% |
| Example 6 | 3.07 | 2.62 | 85% |
| Example 7 | 2.69 | 2.52 | 94% |
| Comparative | 2.26 | 1.4 | 62% |
| Example 1 | | | |
| Comparative | 3.26 | 1.98 | 61% |
| Example 2 | | | |
| Comparative | 2.13 | 1.46 | 69% |
| Example 3 | | | |
| Comparative | 1.95 | 1.3 | 67% |
| Example 4 | | | |
| Comparative | 2.33 | 1.61 | 69% |
| Example 5 | | | |

As shown in Table 1 above, it can be seen that the silica insulation composites (Examples 1 to 7) according to the present disclosure have a high thickness recovery rate of 73% or greater even after the two-stage compression process. However, it can be seen that the silica insulation composites of Comparative Examples 1 to 5 have a thickness recovery rate of only in the 60% range after the two-stage compression process.

2. Evaluation of Thickness Recovery Rate after Performing Compression Process Repeatedly

In order to evaluate whether the restoration recovery rate of the silica insulation composite prepared according to the present disclosure is maintained excellent despite repetitive volume changes of a cell during a battery operation, the compression process of 1 above was repeated three times. That is, the initial thickness of the specimen was measured, and the specimen was pressed to have a thickness of 50% of the initial thickness, and then additionally pressed to have a thickness of 40% thereof, and followed by lowering the pressure to allow the specimen to have a thickness of 50% of the initial thickness, and then the specimen was additionally pressed to have a thickness of 40% thereof again. Subsequently, the pressure was lowered to allow the specimen to have a thickness of 50% of the initial thickness, and the specimen was additionally pressed to have a thickness of 40% thereof again. Thereafter, the compression jig was adjusted such that the pressure applied to the specimen became 0, and the final thickness of the specimen was measured. For each example, an average value of the initial thicknesses and an average value of the thicknesses after repeating the compression process three times were calculated for five specimens, and the results were substituted into Equation 1 to obtain a thickness recovery rate. At this time, the thickness recovery rate was rounded to the second decimal place and is shown in Table 2.

TABLE 2

| | | Thickness | Thickness | |
|---|---|---|---|---|
| | | (mm) after | (mm) after | |
| | | performing | performing | |
| | Initial | compression | compression | Thickness |
| | thickness | process one | process three | recovery |
| | (mm) | time | times | rate (%) |
| Example 1 | 2.91 | 2.67 | 2.59 | 89.00% |
| Example 2 | 2.09 | 1.56 | 1.51 | 72.25% |
| Example 3 | 2.33 | 1.7 | 1.68 | 72.10% |
| Example 4 | 2.58 | 2.13 | 1.92 | 74.42% |
| Example 5 | 2.9 | 2.69 | 2.62 | 90.34% |
| Example 6 | 3.07 | 2.62 | 2.41 | 78.50% |
| Example 7 | 2.69 | 2.52 | 2.4 | 89.22% |
| Comparative | 2.26 | 1.4 | 1.12 | 49.56% |
| Example 1 | | | | |
| Comparative | 3.26 | 1.98 | 1.76 | 53.99% |
| Example 2 | | | | |
| Comparative | 2.13 | 1.46 | 1.4 | 65.73% |
| Example 3 | | | | |
| Comparative | 1.95 | 1.3 | 1.15 | 58.97% |
| Example 4 | | | | |
| Comparative | 2.33 | 1.61 | 1.31 | 56.22% |
| Example 5 | | | | |

As shown in Table 2 above, it can be seen that the silica insulation composites (Examples 1 to 7) according to the present disclosure have a high thickness recovery rate of 72% or greater even after the two-stage compression process was repeated three times. However, it can be seen that the silica insulation composites of Comparative Examples 1 to 5 have a thickness recovery rate of only in the 50% range after the two-stage compression process was repeated three times.

A silica insulation composite according to the present disclosure has excellent restoration elasticity against compression. Therefore, if the silica insulation composite is applied as an insulation member for a battery, structural stability and insulation performance may be maintained despite repeated volume changes due to expansion and contraction of a cell that occurs during charging and discharging of the battery.

Through the above-described experiments, it can be seen that the insulation member including the silica insulation composite according to the present disclosure has elasticity recovery against multi-stage compression, thereby effectively accommodating periodic volume changes of a cell that occur during charging and discharging of a battery, resulting in suppressing degradation in insulation.

### DESCRIPTION OF THE REFERENCE NUMERALS OR SYMBOLS

100: Silica insulation composite
200, 200′: Film
S1, S2: Sealing portion

What is claimed is:

1. An insulation member comprising:
a silica insulation composite comprising a substrate and a silica network structure, the silica network structure including a plurality of silica particles and one or more pores; and
a film positioned on a first surface of the silica insulation composite and a second surface of the silica insulation composite,
wherein the insulation member has a thickness recovery rate of 70% or greater after a compression process, the thickness recovery rate calculated according to Equation 1:
$$Thickness recovery rate \text{} ( \% ) = [ Thickness of insulation member after secondary compression ] \text{} / [ \text{} Thickness of insulation member before compression ] \times 100 \qquad [ Equation 1 ]$$
wherein in Equation 1, the thickness of the insulation member after secondary compression is a thickness of the insulation member after subjecting the insulation member to the compression process, the compression process comprising subjecting the insulation member to a primary compression until a thickness of the insulation member reaches 50±5% of the thickness of the insulation member before the compression process, wherein the primary compression is maintained for 60 minutes, followed by subjecting the insulation member to a secondary compression until a thickness of the insulating member reaches 40±5% of the thickness of the insulation member before the compression process, wherein the secondary compression is maintained for 60 minutes, and then subjecting the insulating member to an environment without the pressure for 6 minutes.

2. The insulation member of claim 1, wherein the insulation member has a thickness recovery rate (%) of 68% or greater after the compression process is repeated two or more times.

3. The insulation member of claim 1, wherein the insulation member has a thickness recovery rate (%) of 68% or greater after the compression process is repeated three times.

4. The insulation member of claim 2, wherein a thickness of the insulation member measured after two or more repetitions of the compression process is 0.90 times or greater than a thickness of the insulation member measured after one repetition of the compression process.

5. The insulation member of claim 1, wherein the insulation member has a thickness of 0.5 mm to 10 mm.

6. The insulation member of claim 1, wherein the plurality of silica particles comprises silica, methylsilylated silica, dimethylsilylated silica, trimethylsilylated silica, or a mixture thereof.

7. The insulation member of claim 1, wherein the silica network structure comprises a particle in which a portion of the plurality of silica particles are aggregated or coupled, and wherein the portion of the plurality of silica particles have a particle diameter of greater than 0 nm to 5 nm.

8. The insulation member of claim 7, wherein the at portion of the plurality of silica particles have an average particle diameter of 5 nm to 2,000 nm.

9. The insulation member of claim 1, wherein the silica insulation composite has a density of 0.05 g/cm³ to 0.50 g/cm³.

10. A battery module comprising one or more battery cells in an internal space; and the insulation member of claim 1.

11. A battery pack comprising the battery module of claim 10.
